(19) United States
(12) Patent Application Publication
(10) Pub. No.: US 2008/0032555 A1
(43) Pub. Date: Feb. 7, 2008

(54) Electrical connector assembly

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/716,032

(22) Filed: Mar. 9, 2007

(30) Foreign Application Priority Data
Aug. 3, 2006 (CN) 200620062500.9

(51) Int. Cl. H01R 13/648

(52) U.S. Cl. 439/608

(57) ABSTRACT

The present invention is to provide an electrical connector assembly to ensure a good electrical connection between a chip and a circuit board. In order to achieve the object described above, the present invention provides an electrical connector assembly electrically connecting a chip module onto a circuit board, comprising: an insulating body, which is fixed on the circuit board through a fixing device, on which at least a hole is formed; a plurality of electrical terminals disposed in the insulating body; and a pressing plate, which is connected to one end of the insulating body for retaining the chip module such that the chip module are compressingly contacted with the electrical terminals, and one end of which is disposed with a retaining piece pivotally connected to the insulating body after being inserted through the hole. Compared with conventional prior art, the electrical connector assembly according to present invention can prevent the internal stress from causing the solder crack at the solder joints of the two ends of the insulating body. The reliability of the electrical connector can then be greatly enhanced, thereby ensuring a good electrical contact between the chip and the circuit board.

### FIELD OF THE INVENTION

The present invention relates to an electrical connector assembly and in particular to an electrical connector assembly which connects a chip module onto a circuit board.

### BACKGROUND OF THE INVENTION

With increasing integration of system technology for multimedia, communication, and computer, the functions of hand-held computers and notebook computers are getting powerful and thus the circuit design of their mother boards is getting more sophisticated. Notebook computer, in particular, has to accommodate increasing number of devices in a limited space, and therefore the design and arrangement of the devices on the mother board are therefore crucial.

At the present time, an electrical connector assembly is generally used to connect a chip module onto a circuit board. An existing electrical connector assembly, as shown in FIG. 4, comprises a upper housing 100, a lower housing 200, a rocking arm 400, and an insulating body 300 for accommodating a plurality of terminals therein. The lower housing 200 of the electrical connector assembly is usually a square frame, in which the insulating body 300 is received. After the insulating body 300 is installed onto the circuit board 600 by soldering the ends of the terminals in the insulating body 300, the lower housing 200 is in the mean time locked between the insulating body 300 and the circuit board 600. As shown in FIGS. 5 and 6, a central processing unit chip 500 is mounted onto the insulating body 300 and then the upper housing 100 is engaged with the lower housing 200. Consequently, a retaining portion on the upper housing 100 exerts a downward force to retain the central processing unit chip. According to the stress analysis, the retaining portion of the upper housing 100 will experience an upward reaction. Since the upper and lower housings are connected with their two ends, the two ends of the lower housing 200 may warp upwardly under the forces F1 and F2, and thus the two ends of the insulating body 300 are driven to bend upwardly as a result. The solder joint 3100 on the two ends of the insulating body 300 may then solder crack and disconnect from the circuit board 600. Consequently, the electrical connector assembly cannot work properly and thus the electrical connection between the chip 500 and the circuit board 600 is seriously damaged.

It is therefore necessary to provide a novel electrical connector assembly to overcome the drawbacks described above.

### SUMMARY OF THE INVENTION

An object of the present invention is to provide an electrical connector assembly to ensure a good electrical connection between a chip and a circuit board.

In order to achieve the object described above, the present invention provides an electrical connector assembly electrically connecting a chip module onto a circuit board, comprising: an insulating body, which is fixed on the circuit board through a fixing device, on which at least a hole is formed; a plurality of electrical terminals disposed in the insulating body; and a pressing plate, which is connected to one end of the insulating body for retaining the chip module such that the chip module are compressingly contacted with the electrical terminals, and one end of which is disposed with a retaining piece pivotally connected to the insulating body after being inserted through the hole.

Compared with conventional prior art, the electrical connector assembly according to present invention can prevent the internal stress from causing the solder crack at the solder joints of the two ends of the insulating body. The reliability of the electrical connector can then be greatly enhanced, thereby ensuring a good electrical contact between the chip and the circuit board.

### BRIEF DESCRIPTION OF THE DRAWINGS

The present invention can be more fully understood by reference to the following description and accompanying drawings, in which:

FIG. 1 schematically illustrates exploded perspective views of an electrical connector and a suction plate according to the present invention;

FIG. 2 schematically illustrates an exploded perspective view of an electrical connector assembly according to the present invention;

FIG. 3 schematically illustrates the exploded perspective view of the FIG. 2 from another view angle;

FIG. 4 schematically illustrates an exploded perspective view of an conventional electrical connector assembly;

FIG. 5 schematically illustrates a side cross-sectional view of the electrical connector assembly show in FIG. 4 in an open status; and

FIG. 6 schematically illustrates a side cross-sectional view of the electrical connector assembly shown in FIG. 4 in a close status.

### DETAILED DESCRIPTION OF THE PREFERRED EMBODIMENTS

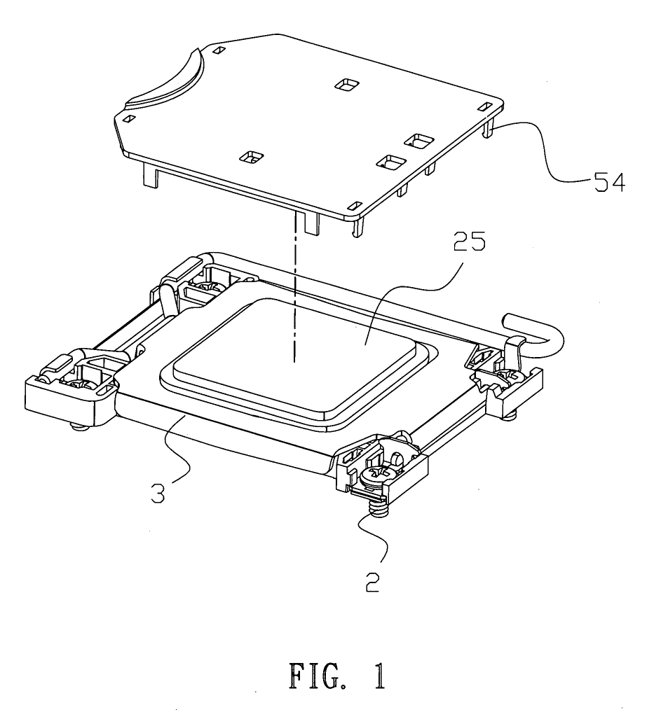

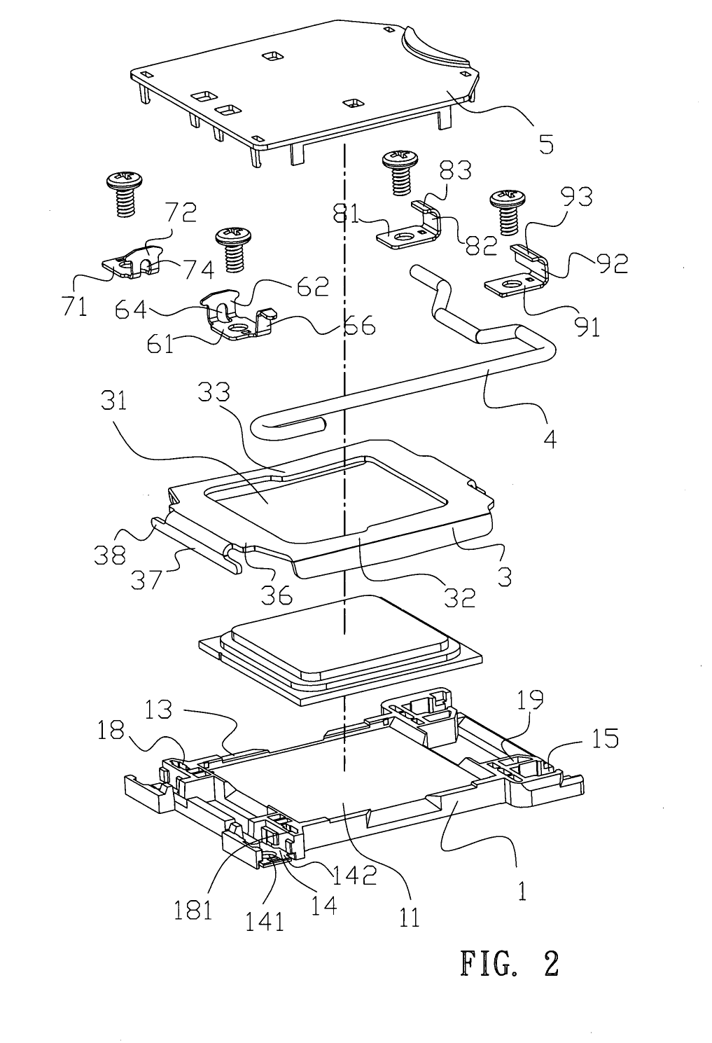

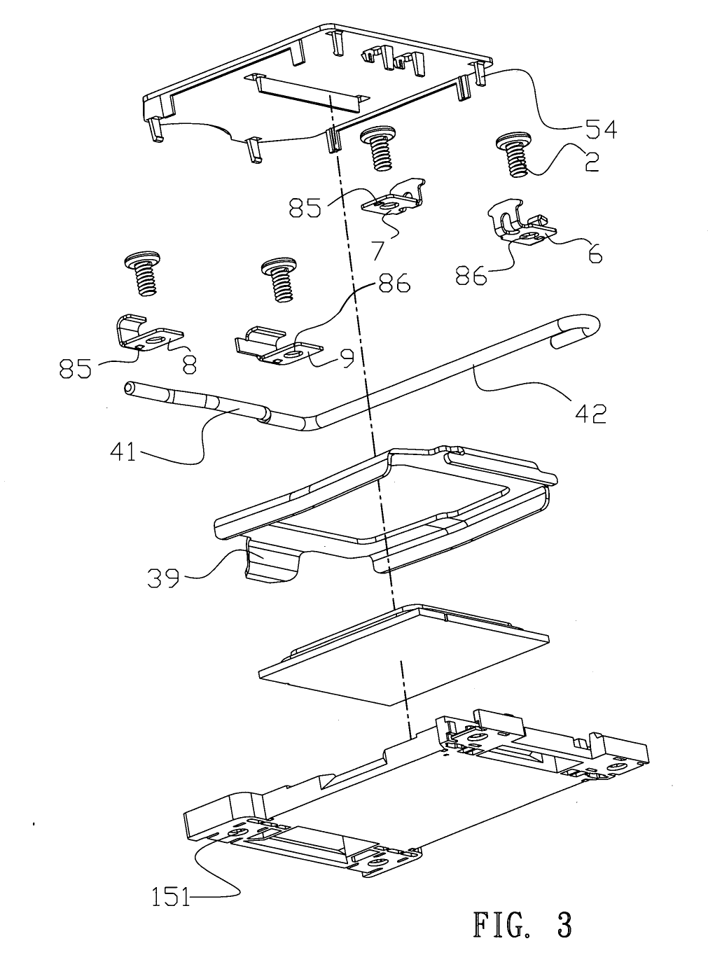

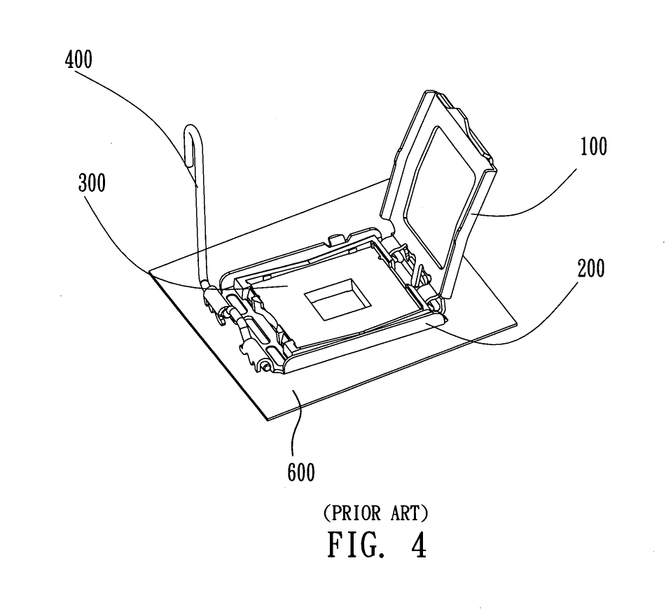

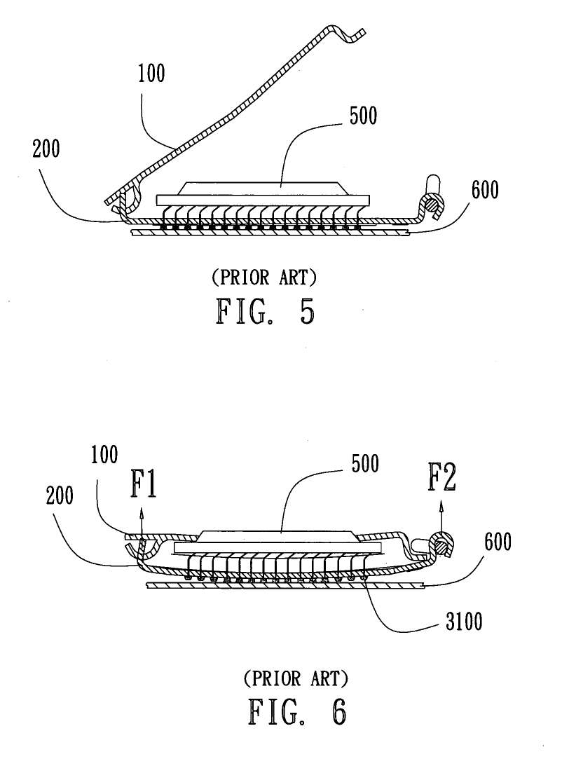

With reference to FIGS. 1 to 3, an electrical connector assembly according to the present invention is to connect a chip module 25 onto a circuit board (not shown), comprising an electrical connector and a suction plate 5, wherein the electrical connector comprises an insulating body 1, electrical terminals (not shown), and a pressing plate 3 and an activating rod 4 pivotally connected onto two ends of the insulating body 1. The activating rod 4 comprises a clasping portion 41 and an activating portion 42 extending from one end of the clasping portion 41. The pressing plate 3 is pivotally connected onto the insulating body 1 through a fixing device, which consists of a first locating part 6 and a second locating part 7 in the present embodiment. The activating rod 4 is pivotally connected onto the insulating body 1 through a third locating part 8 and a fourth locating part 9. Two ends of the insulating body 1 are disposed with accommodating chambers, into which the locating parts described above may be inserted for fixing. The suction plate 5 is disposed with a flat and smooth suction potion in the middle and may be assembled upon the insulating body 1.

The insulating body 1 of the electrical connector is fixed onto the circuit board through a fixing device (a screw 2 in the present embodiment), comprising an accommodating space 11 for accommodating the chip module 25 therein and a plurality of terminal accommodating chambers (not shown) disposed in the accommodating space 11 for accommodating electrical terminals. A locating edge block 13 higher than the terminal accommodating chambers is disposed on one side of the insulating body 1. The accommodating chamber comprises a first accommodating chamber 14 and a second accommodating chamber 15, wherein the first accommodating chamber 14 is formed to have a first round hole 141 on its bottom for the insertion of the screw 2 therethrough and fastening the insulating body 1 onto the circuit board, and a first channel 18 adjacent to the first accommodating chamber 14 is disposed with a first retaining portion 181, and a horizontal slot 142 is disposed on the bottom of the first accommodating chamber 14 for accommodating a first horizontal fixing portion 61 of the first locating part 6; the second accommodating chamber 15, like the first accommodating chamber 14, is formed to have a second round hole 151 for insertion of the screw 2 therethrough and fastening the insulating body 1 onto the circuit board, and the second channel 19 adjacent to the second accommodating chamber 15 is disposed with a second retaining portion (not shown).

The pressing plate 3 may hold down the chip module 25 such that the chip module 25 is compressingly contacted with electrical terminals. The roughly center of the pressing plate 3 is formed to have a through hole 31; two edges of the through hole 31 extends roughly from their centers inwards, respectively, to form a clasping portion 32, which is an indented arc surface such that the upper surface of the pressing plate 3 is disposed with a symmetrical indented zone 33 at each side, respectively. The pressing plate 3 extends forwards to form a protruding portion 36 from two sides of one end, respectively. The protruding portion 36 bends downwards and extends to form a vertical portion 37, two sides of which extend outwards to form a retaining piece 38, respectively, which further renders the pressing plate 3 rotating with respect to the insulating body 1. A coordination plate 39 of arc cross section is disposed at the middle of the other end of the pressing plate 3 and may coordinate with the clasping portion 41 of the activation rod 4.

The locating part 6 comprises a first horizontal fixing portion 61 fixably in the first accommodating chamber 14 and a first vertical portion 62 upwardly extending from the first horizontal fixing portion 61. A first retaining hole 64 is formed at the intersection between the first fixing horizontal portion 61 and the first vertical portion 62 to retain with the retaining piece 38 on the pressing plate 3. Further, one end of the first locating part 6 bends sideways upwardly, extends and bends forwardly, and then horizontally bends to form a retainer 66 to retain the activating rod 4. The second locating part 7 comprises a second horizontal fixing portion 71 fixably in the first accommodating chamber 14 and a second vertical portion 72 upwardly extending from the second horizontal fixing portion 71. A second retaining hole 74 is formed at the intersection between the second horizontal fixing portion 71 and the second vertical portion 72 to retain with the retaining piece 38 on the pressing plate 3. The pressing plate 3 is pivotally connected onto the insulating body 1 through the first locating part 6 and the second locating part 7. The retaining piece 38 of the pressing plate 3 is engaged to the first retaining hole 64 of the first locating part 6 and the second retaining hole 74 of the second locating part 7 to achieve the pivotal connection. The third locating part 8 comprises a third horizontal fixing part 81 fixably in the second accommodating chamber 15, a third vertical portion 82 extending upwardly from the third horizontal fixing part 81, and a third clamping portion 83 upwardly bending from the upper portion of the third vertical portion 82. The fourth locating part 9 comprises a fourth horizontal fixing part 91 fixably in the second accommodating chamber 15, a fourth vertical portion 92 extending upwardly from the fourth horizontal fixing part 91, and a fourth clamping portion 93 upwardly bending from the upper portion of the fourth vertical portion 92. The activating rod 4 is pivotally connected onto the insulating body 1 through the third locating part 8 and the fourth locating part 9. The pivotal connection is achieved by pressing down the activating rod 4 upon the third clamping plate 83 of the third locating part 8 and the fourth clamping plate 93 of the fourth locating part 9, wherein each locating part is downwardly stamped to form a small spring slice 85 to achieve better fastening with the insulating body 1 and the center of each horizontal fixing portion is formed to have a through hole 86 for the insertion of the screw 2.

The suction plate 5 with a shape roughly identical to the pressing plate 3 has a chamfer on each side of one end and an arc surface on its middle. The suction plate 5 is positioned upon and covering the whole pressing plate 3. Four corners of the suction plate 5 extend downwardly to form a retaining hook 54, respectively, which coordinates with the retaining portions on the insulating body 1 to retain the suction plate 5 onto the insulating body 1.

While the invention has been described with reference to the a preferred embodiment thereof, it is to be understood that modifications or variations may be easily made without departing from the spirit of this invention, which is defined by the appended claims.

What is claimed is:

1. An electrical connector assembly for connecting a chip module onto a circuit board, comprising:
an insulating body, which is fixed on the circuit board through a fixing device, on which at least a hole is formed;
a plurality of electrical terminals disposed in the insulating body; and
a pressing plate, which is connected to one end of the insulating body for retaining the chip module such that the chip module are compressingly contacted with the electrical terminals, and one end of which is disposed with a retaining piece pivotally connected to the insulating body after being inserted through the hole.

2. The electrical connector assembly as claimed in claim 1, further comprising an activating rod pivotally connected onto the other end of the insulating body for fixing the pressing plate.

3. The electrical connector assembly as claimed in claim 2, wherein the activating rod comprises a clasping portion and an activating portion extending from one end of the clasping portion.

4. The electrical connector assembly as claimed in claim 3, wherein a coordination plate of arc cross section is disposed at the middle of the other end of the pressing plate and may coordinate with the clasping portion of the activation rod.

5. The electrical connector assembly as claimed in claim 1, wherein the fixing device further comprises a first locating part and a second locating part pivotally connected onto the pressing plate.

6. The electrical connector assembly as claimed in claim 5, wherein one end of the first locating part bends sideways upwardly, extends and bends forwardly, and then horizontally bends to form a retainer to retain the activating rod.

7. The electrical connector assembly as claimed in claim 6, wherein the holes are the first retaining hole and the second retaining hole which may retain the retaining piece of the pressing plate.

8. The electrical connector assembly as claimed in claim 5, wherein the fixing device further comprises a third locating part and a fourth locating part pivotally connected onto the activating rod.

9. The electrical connector assembly as claimed in claim 1, further comprising a suction plate positioned upon and covering the whole pressing plate.

10. The electrical connector assembly as claimed in claim 9, wherein the suction plate is disposed with a flat and smooth suction potion in the middle and may be assembled upon the insulating body.
